(19) United States
(12) Patent Application Publication
(10) Pub. No.: US 2006/0072531 A1
(43) Pub. Date: Apr. 6, 2006

(54) Communication network

(76) Inventors: Carrel W. Ewing, Reno, NV (US); James P. Maskaly, Sparks, NV (US); Brian Auclair, Reno, NV (US); Jay Williams, Yankton, SD (US); Mark Bigler, Eugene, OR (US)

Correspondence Address: KLARQUIST SPARKMAN, LLP, 121 SW SALMON STREET, SUITE 1600, PORTLAND, OR, 97204, US

(21) Appl. No.: 11/244,132

(22) Filed: Oct. 4, 2005

Related U.S. Application Data
(60) Provisional application No. 60/616,593, filed on Oct. 4, 2004.

(51) Int. Cl. H04Q 7/24; H04Q 7/20

(52) U.S. Cl. 370/338; 455/445

(57) ABSTRACT

The present disclosure provides methods, systems, and apparatus for communicating with an electronic device. Particular disclosed embodiments provide a system that includes a peripheral communications adapter communicatingly connectable to an electronic device. The peripheral communications adapter includes a first communications interface, a second communications adapter communicatingly connectable with the electronic device, a memory, and a processor. The system also includes a controller in communications with the first communications interface. The controller includes a network adapter connectable to a network, a first communication port communicatingly connectable to the first communications interface, and a processor. The systems allows a remote user to monitor or control the electronic device over the network.

### CROSS REFERENCE TO RELATED APPLICATION

This application claims the benefit of, and expressly incorporates by reference in its entirety, U.S. Provisional Patent Application No. 60/616,593, filed Oct. 4, 2004.

### BACKGROUND

1. Technical Field

The present disclosure relates to apparatus, systems, and methods for communicating with at least one electronic device, such as a device in an electronic equipment rack. Certain embodiments provide such apparatus, systems and methods that allow for an electronic device to communicate with a controller, which in turn may communicate with a remote user.

2. Description of Related Art

Electronic equipment racks, such as RETMA racks, commonly include rectangular or box-shaped housings or rack structures. Electronic devices, such as servers, routers, uninterruptible power supplies (UPSs) and power distribution units (PDUs), are commonly mountable in such racks so that the various electronic devices are aligned vertically one on top of the other in the rack. Multiple racks are often oriented side-by-side, with each rack containing numerous electronic devices. Each of the racks includes substantial quantities of associated component wiring located both within and outside of the area occupied by the racks.

Some electronic devices allow for remote monitoring and control of the electronic device. For example, certain PDUs allow a user to remotely monitor and control the PDU or devices attached to the PDU. Examples of such PDUs can be found in U.S. Pat. Nos. 5,506,573, 5,949,947, and 6,711,613, which are expressly incorporated by reference in their entireties (although in the case of any inconsistency with the present disclosure, the present disclosure shall control).

Software based management applications have also been used to communicate with remote electronic devices. Examples of such management applications include the Unicenter software package available from Computer Associates International, Inc. of Islandia, N.Y., and the Tivoli software package available from IBM Corp. of White Plains, N.Y. Hewlett-Packard Co. of Palo Alto, Calif. sells a software package by the name of OpenView, which allows access to servers using “Lights Out” technology. “Lights Out” functionality can be integrated into the server or can be added later by equipping the server with a “Lights Out” card. “Lights Out” technology, in associated with a suitable management application, can provide a user with a variety of functions, including remote power control and reboot.

While it can be beneficial to remotely monitor and control electronic equipment located in a rack, typical systems suffer from a number of deficiencies. As an example, each discrete piece of electronic equipment in the rack typically requires its own IP address if the piece is to be remotely controlled via an IP network. As the number of IP addresses increases, setup can become more complicated and communication can become less efficient. In addition, IP addresses are typically in short supply and it may be difficult to obtain the number of IP addresses needed to communicate with each electronic device in each rack, particularly in organizations that use a large number of racks. Even if such IP addresses are available, the number of wires inside or connected to a particular rack can be quite large.

As another example, the various types of equipment in a given rack often require different communication protocols, or portions of protocols, in order to provide the desired remote control and monitoring. Typically, different communication protocols use different types of network connections, and often separate remote control access software is needed for each piece of equipment, or at least each type of equipment, in a given rack.

Typical busses used to interconnect components in an equipment rack also typically have some undesirable properties. For example, the buss may be limited to a certain length, limiting how far apart components may be placed. Such busses may preclude interconnecting components in different racks, or interconnecting a rack component with a component outside the rack. Such busses are typically limited in the number of devices which can be interconnected using the buss.

### SUMMARY

Various embodiments of the present disclosure provide apparatus, systems, and methods for communicating with one or more electronic devices, such as electronic devices in a data center cabinet, such as uninterruptible power supplies, sensors, contact closures, terminal servers, servers, routers, and power distribution units. In a particular implementation, the present disclosure provides apparatus, systems, and methods for connecting, and remotely controlling or monitoring, a plurality of power supplies, such as power supplies capable of supplying multiphase power, such as three phase power.

When multiple electronic devices are present, in certain embodiments, the devices are located in a single rack, such as a RETMA rack. In other embodiments, at least one device is located in a rack and another device is not located in the rack, such as being located in a different rack. Of course, the electronic devices need not be located in, or associated with, a rack. When located in the rack, the electronic devices can be mounted vertically or horizontally within the rack.

Certain embodiments include a controller, which may be independent, such as being located in a housing, or may be integrated into an electronic device such as a server or a PDU. In certain embodiments, the controller is mounted in a rack, such as a RETMA rack. In such embodiments, the controller may be vertically or horizontally mounted. In alternate embodiments, the controller is located outside the rack, such as adjacent to, or remote from, the rack.

Certain disclosed embodiments include a controller having a communication module for sending information to, or receiving information from, electronic devices or a remote user. In particular embodiments, the controller uses a variety of communication protocols in order to communicate with a variety of electronic devices. The controller may also include a number of protocol modules that may be transferred to electronic devices. These modules may be stored in a changeable memory so that modules may be added, updated, or removed as needed. In other implementations, the protocol modules are stored in a fixed memory. The stored protocols can include network protocols, device protocols, and communication subsystem protocols, such as buss protocols.

The controller may have a communications controller, such as a communications buss, in order to interface with external devices. In certain embodiments, the communications controller is configured to interact with a plurality of communication busses in order to interface with a variety of external devices. In a particular implementation, the buss is a Controller Area Network, or CAN, buss. In another particular implementation, the communications controller enables wireless communication. The communications controller may be integrated into other controller components, such as the processor, or may be a separate component.

The controller may include one or more communications interfaces for communicating with devices. The devices may communicate with the controller in a daisy-chain manner, may form a multi-drop network, or may be connected in a star configuration.

In particular embodiments, the controller includes a network adapter for communicating with a network. In particular implementations, the controller communicates with the network using a network protocol such as Ethernet, SNMP, TCIP/IP, or http. The controller may be assigned a particular address on the network.

The present disclosure provides a peripheral communications adapter (PCA), and associated systems and methods, which allows an electronic device to communicate with the controller. The PCA may be attachable to, or integrated into, an electronic device. In other implementations, the PCA is spaced apart from, but in communication with, its associated electronic device. The PCA and the electronic device may be located in the same rack as the controller, or may be located outside such rack, such as being located in a different rack than the controller, or not being located in a rack. In another embodiment, at least two controllers are provided, with each controller communicating to a subset of the PCA's.

The PCA may be provided with suitable connectors to interface with a variety of electronic devices. The PCA may also have a controller interface, such as a buss interface, to interface with the controller through a buss, such as a CAN buss. In at least one implementation, the controller interface provides wireless communication with the controller. In alternative implementations, the PCA is physically connected to an input of the controller, such as by wire or cable. In certain embodiments, PCAs may be daisy chained together, organized as a multi-drop architecture, and connected to an input of the controller. In further embodiments, PCAs are connected to the controller in a star architecture through multiple ports on the controller.

The PCA may be provided with a memory. The memory may store data, including communication protocols, such as device protocols and communication subsystem protocols, such as buss protocols. In certain embodiments, the PCA communicates with the controller to obtain a suitable protocol module to allow the PCA to operate with the electronic device to which it is attached. The PCA may communicate with the attached electronic device in order to obtain data indicative of the needed protocol. The PCA, such as the memory of the PCA, may contain a protocol polling module to facilitate such communication. In particular embodiments, the PCA can poll the controller to determine if an updated or revise protocol is available. In further embodiments, the PCA is preprogrammed with one or more protocols associated with the electronic device with which the PCA is to be used.

The PCA may contain a processor in order to facilitate communications with the controller or electronic device, or to interpret data from such communications. For example, the PCA may receive data from an electronic device, process the data to determine the status of the electronic device, and then communicate the status of the electronic device to the controller. In other implementations, the PCA forwards data to the controller, which then processes or interprets the data. The processor, memory, and connectors may separate or one or more of these components may integrated.

Systems employing the disclosed controllers and PCAs allow a remote user to monitor or control electronic devices. For example, the remote user may monitor the amount of power drawn by an electronic device, the on/of status of a device, or other operational parameters. Certain disclosed systems allow a remote user to alter an operational parameter of an electronic device, such as turning the device off or on, or rebooting the device. In particular implementations, the remote user communicates with the controller through a management application.

In particular disclosed methods, the remote user may issue a request, such as a monitoring or controlling request, to an electronic device. The request is sent from the remote user, optionally through a management application, over a network to the controller. The controller processes the request and transmits the request to the peripheral communications adapter. The peripheral communications adapter processes the request and, in a particular implementation, transmits the request to the electronic device. In other particular implementations, the PCA has previously communicated with the electronic device and responds to the request using previously obtained data. For example, the PCA may be in constant communication with the electronic device, such as in order to respond to a request from the controller.

The electronic device, based on the request, transmits operational data or changes an operational parameter as directed by the request. When operational data is transmitted by the electronic device, the operational data may be transmitted to the PCA, optionally processed by the PCA, and transmitted to the controller from the PCA, and processed by the controller and transmitted to the remote user over the network, optionally through the management application. The requests may be encoded in a buss protocol or a device protocol, as appropriate, for communication to the PCA, or the electronic device. In further embodiments, the PCA or electronic device send unsolicited data to the controller.

Certain embodiments provide a system for communicating with one or more electronic devices though a controller without the need to assign each electronic device a network address, such as an IP address. The controller in this embodiment of the disclosure controls multiple electronic devices through multiple PCAs. In some cases, the controller controls 50 or more devices, which, in certain implementations, requires a corresponding number of PCAs. Each of the PCAs communicates with the controller, and communicates outside the controller using the network address of the controller. Thus it is not necessary to assign additional network addresses to each PCA. In addition to conserving network addresses, and potentially simplifying setup and control of equipment, having fewer network addresses may reduce the amount of wiring inside a rack or connected to a rack. Fewer network connections may also result in more efficient and reliable communication. In other embodiments of the disclosure, the controller includes more than one network address.

In certain embodiments, the disclosed systems and methods employ network security. In some embodiments of a secure system, access to the electronic devices requires user authentication. For example, user authentication may be checked against a pre-configured user database. A secure proxy is used in some embodiments of the disclosure, providing a secure tunnel through which non-secure local host network data and commands are sent. In further embodiments Secure Socket Layer (SSL), Secure Shell (SSH), Transport Security Layer (TSL), or Secure SNMP technology is used to secure communications.

Compared to prior apparatus, systems, and methods, the present disclosure provides apparatus, systems, and methods that provide a number of benefits. For example, the present disclosure provides systems and apparatus that may be less expensive than prior systems and apparatus. Where prior apparatus are typically only available in discrete architecture sizes, the present disclosure provides apparatus and systems that are scalable or adaptable, providing greater flexibility in designing systems and allowing for expandable and efficient systems. For example, devices may be connected over a greater range than previous systems, including between multiple equipment racks. Certain embodiments of the present disclosure also provides for a greater number of connected components than prior systems. A simplified interface and central management are additional advantages of the disclosed systems.

There are additional features and advantages of the subject matter described herein. They will become apparent as this specification proceeds.

In this regard, it is to be understood that this is a brief summary of varying aspects of the subject matter described herein. The various features described in this section and below for various embodiments may be used in combination or separately. Any particular embodiment need not provide all features noted above, nor solve all problems or address all issues in the prior art noted above.

### BRIEF DESCRIPTION OF THE DRAWINGS

The description herein makes reference to the accompanying drawings wherein like reference numerals refer to like parts throughout the several views, and wherein:

FIG. 1 is schematic diagram of an embodiment of a communication system according to an aspect of the present disclosure.

FIG. 2 is a schematic diagram depicting the interaction between a controller and a peripheral communication adapter.

FIG. 3 is a schematic diagram of electronic devices connected to a controller in a daisy-chain configuration.

FIG. 4 is a schematic diagram of electronic devices connected to a controller in a star configuration.

FIG. 5 is a flow chart illustrating an embodiment of a method for detecting what protocol is needed by a peripheral communication adapter and for transmitting the protocol to the peripheral communication adapter from the controller.

FIG. 6 is a schematic diagram depicting the interaction between a management application, a controller, and an electronic device in communication with the controller.

### DETAILED DESCRIPTION

As used herein, the singular forms “a,” “an,” and “the” refer to one or more than one, unless the context clearly dictates otherwise. As used herein, the term “includes” means “comprises.”

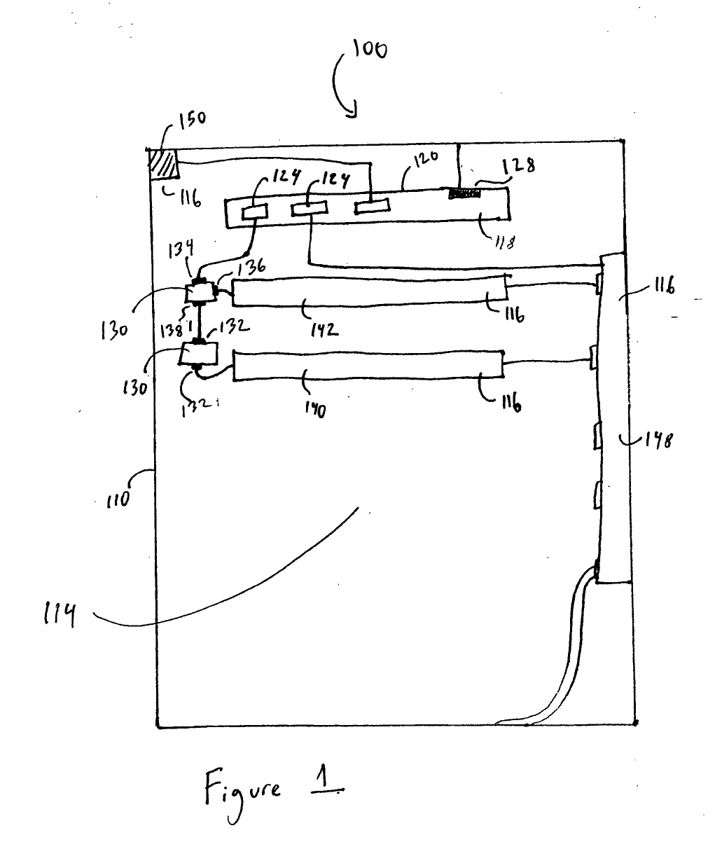

FIG. 1 is a schematic diagram illustrating components of a communication network 100, which may be used to allow communications with devices in an equipment rack. Communication network 100 includes a rack 110, which may be a RETMA rack. The rack has a central interior space 114 where a variety of electronic devices 116 may be mounted. Electronic devices 116 may be mounted horizontally, as are electronic devices 140, 142, or vertically, such as electronic device 148. Some examples of electronic devices 116 include power distribution units (PDUs), including PDUs capable of delivering multi-phase power, environmental sensors (such as temperature and humidity sensors), uninterruptible power supplies (UPSs), network devices (such as servers), terminal servers, computers (including digital information routers and switches), contact closures/security, and content servers/distributors (such as those used for distributing content from a satellite link).

A communication controller 118 is mounted in the rack 110. As shown, the communication controller 118 is mounted in a housing 120. The communication controller 118 could be integrated into another device, such as an electronic device 116. The housing (or device into which the communication controller 118 is integrated) can be mounted horizontally in the rack 110, as shown, or vertically. Although shown mounted in the rack 110, the communication controller could be located on the exterior of the rack 110, or located remotely from the rack 110. In certain embodiments, the rack 110 is omitted.

In at least some implementations, there are at least two communication controller's 118. In such a case, electronic devices 116 will be assigned a specific communication controller 118 based on some protocol. In an exemplary embodiment, one communication controller is used for complex devices 116, and another communication controller is used for simpler devices 116. Other embodiments which divide the devices between the communication controller's 118 based on other criteria are also considered.

The communication controller 118 has a plurality of communications ports 124, such as buss ports, which may be connected to one or more of the electronic devices 116. However, particularly when a daisy chain or multi-drop architecture is used, the communication controller 118 may have a single communication port 124. The communication controller 118 also has a network connection, or adapter, 128. The network connection 128 connects the communication controller 118 to a network, which may be the Internet, an intranet, a local area network (LAN), a wide area network (WAN), a virtual private network (VPN), or any other suitable network. The network may operate using any suitable protocol, such as SNMP, TCP/IP, http, or Ethernet.

The electronic devices 116 may be connected to the communication controller 118 in a variety of configurations including a daisy chain, multi-drop architecture, or star structure. For example, as shown in FIG. 1, electronic devices 140 and 142 are connected to the communication controller 118 in a daisy chain configuration. FIG. 1 shows electronic devices 148 and 150 connected to the communication controller 118 individually in a star configuration.

The communication controller 118 is in communication with each electronic device 116 through a peripheral communication adapter (PCA) 130. The PCAs 130 have a plurality of adapters 132. An adapter 134 interfaces with the communication controller 118. An adapter 136 interfaces with an electronic device 142. An adapter 138 interfaces with another PCA 130. The PCAs 130 may be constructed with any desired number of adapters. The PCA 130 can be designed such that it functions with up to 256K of read-only memory (ROM) and up to 16K of random access memory (RAM).

The communication controller 118 may communicate with the PCA 130 through any number of protocols. For example, a buss, such as an I2C, SPI, RS232, MOD, or CAN buss may be used to connect the communication controller 118 to the PCA 130. In particular implementations, the buss is a multidrop buss, such as I2C, MOD, or CAN. In other embodiments a network protocol, such as TCP/IP or Ethernet protocols, may be used for communication between the communication controller 118 and the PCA 130. In certain implementations, the communication controller 118 and the PCA 130 communicate using a wireless protocol. Thus, the communication controller 118 and the PCA 130 may form a private network, which may then interface to a public network through the communication controller 118.

In an exemplary embodiment, the communication controller 118 can consist of two busses, a main bus for controlling more complex hardware and a secondary bus for controlling less complex hardware devices.

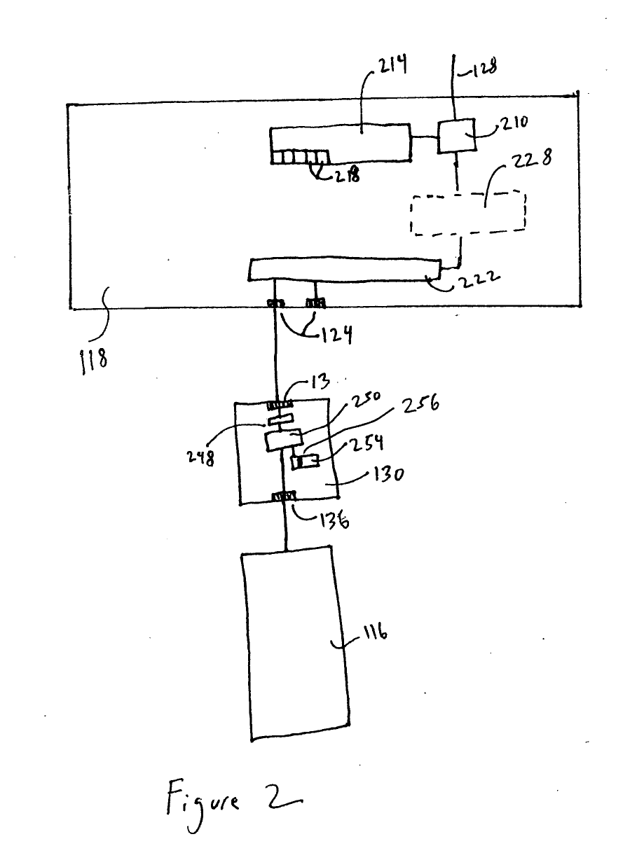

Referring now to FIG. 2, the communication controller 118 has a processor 210 that regulates data transmission and processes data. The processor 210 may be a NetSilicon NET+50 microprocessor available from NetSilicon, Inc. of Waltham, Mass. The processor 210 is in communication with a memory 214 that stores a plurality of protocols 218, such as communication protocols. The memory 214 may be of any suitable type, such as RAM, ROM, flash ROM, EPROM, or EEPROM. In at least certain embodiments, the memory is changeable so that protocols 218 can be added or removed as desired. In other embodiments at least a portion of the memory 214 is static. The protocols 218 may be implemented in a variety of programming languages, including C++. Examples of suitable protocols 218 include SNMP, XCP, SEC, the Tripp Lite protocol, the Magnetec protocol, and the Powerware protocol.

In certain embodiments, the protocols 218 in the memory 214 can be updated. In further embodiments, protocols 218 stored in the communication controller 118 can be updated, such as with a revised or updated protocol 218 is available, and then transmitted to the PCAs 130. In one embodiment, the PCAs 130 periodically query the communication controller 118 to see if their protocol 218 is current. If not, the PCAs 130 may download the updated protocol module from the communication controller 118.

In certain embodiments, the processor 210 is connectable to a remote network, such as through an integrated network adapter. In alternate embodiments, a separate network adapter (not shown in FIG. 2) is included in the communications controller 118, and is in communication with the processor 210. The network interface module can be used to control incoming and outgoing communications.

The communication controller 118 includes a communications subsystem 222, such as a buss. The buss may be of any suitable type, including RS485, RS232, I2C, USB, SPI, or CAN. More than one buss may be present in the communication controller 118. In this way, the communication controller 118 may communicate with a wider variety of devices. In addition, this configuration may provide separate busses for slow and fast devices, or for wire and wireless connections. The PCAs 130 may form a distributed network, such as a distributed RS232 network. The communication controller 118 can be configured to communicate using other protocols, such as Ethernet, TCP/IP, SNMP, and http. The communication controller 118 may be provided with a command line interface.

In certain embodiments, the processor 210 interfaces directly with the communications subsystem 222. In other embodiments, the communications controller 118 includes a communications interface for connecting to the communications subsystem 222. The communications interface may be integrated into the communication controller 118, or may be attached or in communication with the communication controller 118. In other embodiments, the processor 210 interfaces with a buss controller separate from the processor 210, such as the buss controller 228 optionally depicted in FIG. 2. In a particular implementation, the buss controller 228 is the Microchip MCP2515 buss controller, available from Microchip Technology Inc. of Chandler, Ariz. In a more particular implementation, the buss controller 228 interfaces with an SPI interface of the processor 210 and a CAN interface of the communications subsystem 222.

The communications subsystem 222 is connected to the communication ports 124. The communication ports 124 may be various types of connectors, such as RJ45, DB9, USB type connectors, RJ12, or RS232 type connectors. In certain embodiments, the communication ports 124 are designed to be connected to cables. In further embodiments, the communication ports 124 are designed for wireless communication, such using the 802.11 standard. Wireless communication may reduce the amount of wiring in the rack 110 and may increase the distance the PCA 130 may be placed from the communication controller 118. An indicator (not shown), such as an LED, may be associated with each communication port 124 and indicate the status of the communication port 124 or devices attached thereto.

Examples of devices having a network interface, a processor, memory, and a buss are devices available from Server Technology, Inc. of Reno Nev. Such devices include the Power Tower XL, the Fail-Safe PTXL, and the 4820-XL-8.

Each communication port 124 is communicatingly connectable to an adapter 132 on a PCA 130. The PCA 130 includes a communication subsystem controller 248, such as a buss controller. The communication subsystem controller 248 is preferably compatible with the communication subsystem 222. The PCA 130 also contains a processor 250. The PCA 130 contains a memory 254 in communication with the processor 250, which in some embodiments is changeable, such as EPROM, EEPROM, and flash ROM. However, all or a portion of the memory 254 may be fixed, such as when the PCA 130 is preprogrammed with a communication protocol module 256. In at least certain embodiments at least some of the various components of the PCA 130, such as the buss controller 248, the processor 250, or the memory 254, are integrated into a single unit. Such units are available from Phillips Semiconductor, Inc. of Eindhoven, the Netherlands, such as the LPC2129, having an ARM-7 processor and a CAN buss controller.

The PCA 130 includes a second communications port 136, such a buss connector, connected by wire or wirelessly to an electronic device 116. The communications port 134 and the second buss port 136 may be configured to accept any suitable connector, including RJ45, RJ12, DB9, USB type connectors, or RS232 type connectors.

The PCA 130 may further include an indicator (not shown), such as an LED or a more elaborate display such as a digital LED display, to provide an indication of the status of the PCA 130. For example, in one embodiment, the indicator may indicate that the PCA 130 is functional. In further embodiments, the indicator may provide status information regarding the attached device 116, the first communications port 134, or the second communications port 136, including operation parameters of the attached device 116, such as the current drawn by the attached device 116 or the on/off status of the attached device 116.

The PCA 130 may be supplied with power in a number of ways. As shown in FIG. 2, the PCA 130 obtains power through its connection to the communications subsystem 222. The PCA 130 may also be provided with a separate power input (not shown) and connected to a power supply. In at least one embodiment, the PCA 130 is powered by an on-board power supply (not shown), such as a battery. In embodiments where the PCA 130 is integrated into a device 116, the device 116 may power the PCA 130.

The communications controller 118 or PCAs 130 may be provided with firmware. This firmware may be implemented as desired. For example, firmware for the communications controller can be developed using the NetSilicon's Net+Works development environment. This development environment provides the Board Support Package, RTOS, Network Protocol Stacks, Application API, and development toolset. CANOpen, available from CMX Systems Inc., of Jacksonville, Fla., can be used to provide a CAN protocol stack/API that can be implemented in both the communications controller 118 and the PCA 130. This protocol enables communication between the communications controller 118 and the PCA 130. Firmware and protocols can be loaded into the PCA 130 by configuring the PCA 130 with a CANOpen Bootloader. Keil PK-ARM Professional Developers Kit, available from Keil Software, Inc., of Plano, Tex., may be used to provide firmware for the PCA, providing an embedded development environment and RTOS.

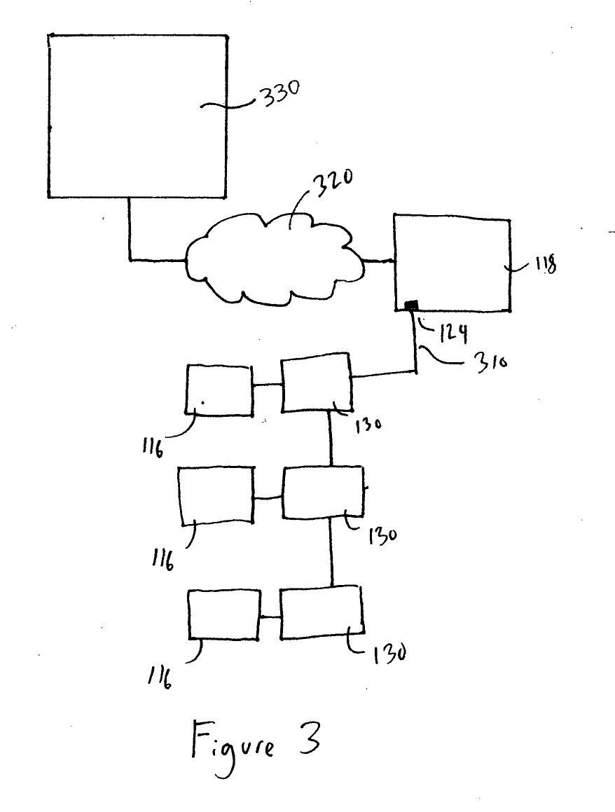

As discussed in conjunction with FIG. 1, the PCAs 130 may be connected to the communication controller 118 in a variety of ways. For example, FIG. 3 illustrates the PCAs 130 connected to the communication controller 118 in a daisy chain, or multidrop, configuration. That is, each PCA 130 is connected to a common input line 310 to the communication controller 118. The communication controller 118 is connected to a network 320. A remote user may thereby communicate with communication controller 118, and the electronic devices 116 attached to the PCAs 130, through a remote workstation 330 in communication with the network 320.

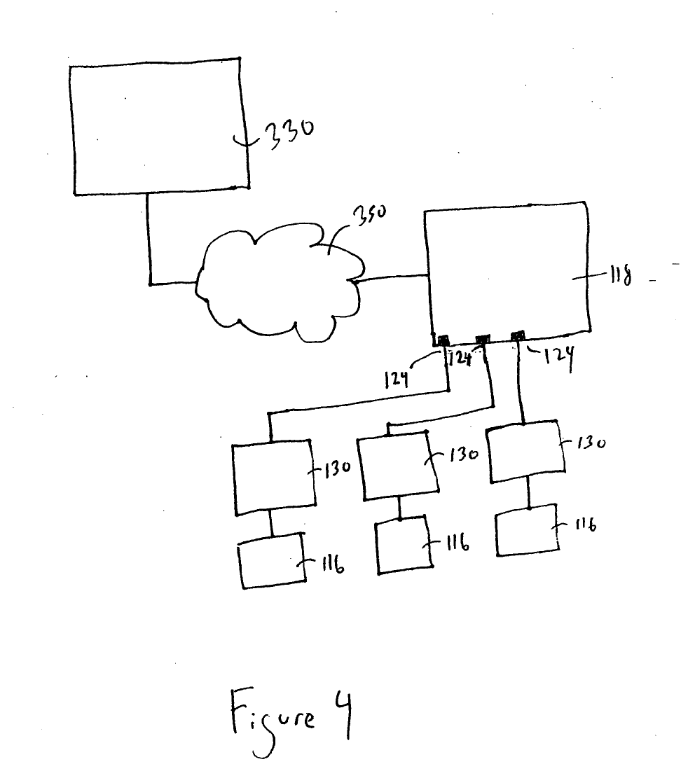

FIG. 4 illustrates an alternative method of connecting the PCAs 130 to the communication controller 118. In FIG. 4, each PCA 130 is connected to a separate communications port 124 on the communication controller 118, thus creating a star network configuration. A remote user can then communicate with the communication controller 118, and the electronic devices 116 attached to the PCAs 130, through a remote workstation 330 in communication with a network 350.

In at least certain embodiments, the PCA 130 has a comparatively limited amount of memory, such as 256 kilobytes of ROM and 16 kilobytes of RAM. Particularly in cases where a limited amount of memory is available, the PCA 130 can be configured so that it does not store every possible protocol in its memory 254, but can dynamically determine what protocol is needed and acquire the needed protocol. For example, in certain implementations, the PCA 130 seeks to determine the appropriate protocol and then requests the appropriate protocol from the communication controller 118. An appropriate polling module can be implemented in the PCA 130 in order to carry out this function. Provision may be made for deleting unused protocols from the memory 254. An update module can be implemented in the PCA 130 communicate with the communication controller 118 and receive updated or revise protocols. In other embodiments, the PCA 130 may be preprogrammed with one or more protocols. For example, a separate PCA 130 could be made for each protocol to be used.

Each PCA 130 is connected to the communication controller 118. The communication controller 118 can send requests to, and obtain information from, the electronic devices 116 attached to the PCAs 130. In certain implementations, the communication controller 118 polls each PCA 130 to determine the type of electronic device 116 connected to the PCA 130. The communication controller 118 also communicates with the PCA 130 to obtain information relating to the electronic device 116 such as status information and data. The request for information may be processed and sent to the electronic device 116, or may be responded to by the PCA 130. For example, in certain embodiments, the PCA 130 is in constant communication the electronic device 116 and responds to request for information on the electronic device 116. The PCA 130 or electronic device 116, in certain embodiments, sends unsolicited information to the controller 118. Commands may be send from the communication controller 118, to the PCA 130, and then to an electronic device 116 in order to control the electronic devices, such as changing the on/off status of the electronic device or initiating a reboot cycle.

The communication controller 118 may communicate with the PCA 130 by any suitable protocol, such as Ethernet, TCP/IP, SPI, RS485, RS232, USB, SNMP, CAN, I2C, or http. In a particular embodiment, the PCA 130 and communication controller 118 communicate by a real time protocol that supports multi-threading, such as an implementation of the CAN protocol. The protocol may place the communication controller 118 in constant communication with the PCA 130. In one implementation of a multi-threaded protocol, a first thread is used to place the PCA 130 in communication with the communication controller 118, a second thread is used to place the PCA 130 in communication with an associated electronic device 116. The first and second threads are placed in communication so that they may exchange information.

As the PCA 130 can connect to various different devices 116, in some exemplary embodiments, the communication controller 118 keeps track of the current electronic devices 116 attached on the communication subsystem 222 (which in an exemplary embodiment is a CAN buss) and detects any changes that may occur. In such an embodiment, PCA control blocks are kept in an array (which can hold up to 64 entries in some embodiments, other embodiments have arrays of different sizes) with one entry for each possible PCA device that may be connected to the communication controller 118 on the communication subsystem 222. An exemplary entry in this array has the following structure:

typedef struct
{

| sn3_header | pcahdr; | // header structure |
|---|---|---|
| unsigned int | pcauid | // unique ID assigned to this device |
| | | // set in hardware via a dip switch |
| | | // 0xffff - UID not assigned - the UID is read from |
| | | // the PCA - ALERT if this value changes |
| unsigned int | pcadevuid | // unique ID of the device attached to the PCA |
| | | // this value is a hash of all the static information |
| | | // calculated by the PCA from data retrieved |
| | | // from the attached device |
| | | // 0xffff- no attached device |
| | | // ALERT if this value changes |
| unsigned int | pcafwver | // current version of firmware loaded on the PCA |
| unsigned char | pcaflag; | // Flag used to indicate if this entry in the array is in use |
| | | // 0xff - never been used |
| | | // 0 - in use |
| | | // 1 - in use - being updated |
| unsigned char | pcadevtype; | // Indicates the general type of device attached |
| | | // 0xff - No attached device |
| | | // 0 - electronic device 116 Device attached |
| | | // 1 - PDU Device attached |
| unsigned int | pcaserialnum | // PCA serial number - unique to each PCA |
| | | // ALERT if this value changes |
| | | // 0xff - uninitialized |
| unsigned char | pcadevndx; | // index into either a STI_UPS or STI_PDU |
| | | // control block structure array |
| unsigned char | reserved[32] | // expansion field |
| sn3_footer | pcaftr; | // foot structure |

} sti_pca_T

In such an embodiment, when the communication controller 118 is initialized, control blocks are read to create the PCA 130 array. Then, the communication controller 118 queries the communication subsystem 222 to retrieve the current configuration and/or status of the PCA 130 devices. The results of this are compared to an expected configuration as retrieved from the control blocks. If a device is detected on the communication subsystem 222 that has been previously discovered but the information concerning the attached device has changed (i.e. the value of the pcadevuid in the sti_pca_T structure has changed), in an exemplary embodiment, a user intervention alert can be generated to resolve this conflict. This mechanism is designed to prevent inadvertent control of an unexpected device. If a PCA 130 unique ID (pcauid) POSITION CHANGE or a PCA 130 serial number (pcaserialnum) has changed but the attached device information (pcadevuid) has not changed, an informational message can be displayed and the operations can then continue without further ado. In some embodiments, in such a situation the behavior at this point is user configurable.

In implementations that employ a CAN buss, the CAN communications protocol can be used to pass information between at least one of the communication controllers 118 and at least one of the PCA's 130. The CAN message API, in an exemplary embodiment, can be implemented by two software subroutines. One such software routine can be implemented in the CAN communications code and can be called as a subroutine from the electronic device 116 monitoring application in the PCA 130 and the communication controller 118 when the electronic device 116 monitoring application wishes to send a message to its partner. This subroutine can be named, in an exemplary embodiment, a2c_send( ). The second subroutine can be implemented as a receive callback routine in the electronic device 116 monitoring application in the PCA 130 and the communication controller 118. In certain embodiments, when the CAN communications code has a message for the electronic device 116 monitoring application, it calls this second subroutine. This subroutine can be named, in an exemplary embodiment, c2a_rcvd( ) (CAN to application receive data).

In some instances, when the electronic device 116 monitoring application either in the communication controller 118 or the PCA 130, has data to send to its partner, it calls a routine which can be named, in an exemplary embodiment, a2c_send. The syntax of the a2c_send routine can have the following example format:
can_sts a2c_send (byte nodeId, can_data_T*data, ULONG wait);

The definition of the values used in an exemplary embodiment can be used as follows:

can_sts can be the status return code returned from the call—three status returns can be defined—CAN_OK, CAN_TO and CAN_FAIL. CAN_OK indicates the operation has been completed and that the data will be sent over the CAN to the partner. CAN_TO indicates the CAN communications code did not have enough buffer space to capture all of the data for transmission in the amount of time specified in the wait parameter. CAN_FAIL indicates the CAN transmission failed (the CAN link is down).

nodeID can be implemented as a one byte address of the communication controller 118 to which the data will be sent. A nodeID of 0 is used to send data from a PCA 130 to the communication controller 118. In a system which allows up to 64 electronic devices 116 for each PCA 130, nodeID values from 1 to 64 are used to address any one of the 64 possible PCA 130 “dongles” when sending data from the communication controller 118 to a PCA 130.

data can be implemented as a pointer to a data structure, can_data_T (in an exemplary implementation) that contains the actual data the will be transmitted to the partner application. The can_data_T structure is described later.

wait can be implemented as a value used to specify the amount of time the program can be suspended waiting for a buffer to be available for the data to be sent. In some implementations, a value of 0 can be used to indicate an infinite wait (no timeout). In other implementations, a different value can be used to indicate an infinite wait time, and in yet other implementations, an infinite wait time value is not allowed.

When the CAN communications code either in the communication controller 118 or the PCA 130 receives data from a node in the network, it calls c2a_rcvd in some implementations. In such a case, example syntax of the c2a_rcvd call can be as follows:
can_sts c2a_rcvd (byte nodeId, can_data_T*data);

The variables, in some implementations, are described below.

can_sts can be used as the status return code returned from the call. In some implementations, the c2a_rcvd can return one of two possible return codes—CAN_OK and CAN_FAIL. CAN_OK indicates the operation has been completed, and, in some embodiments, that the data has been passed to the application for processing. CAN_FAIL, in some implementations, indicates an application error. For example, the error could be that the application cannot accept data from the nodeID specified in the call. Another example error could be that there is not enough buffer space for the data. Other errors are also envisioned. In an exemplary embodiment, there is no “wait” parameter on the c2a_rcvd call as the CAN code is never envisioned to be suspended by the application.

nodeID, in an exemplary embodiment, is a one byte address of the device from which the data was received. A nodeID of 0 indicates the data came from a communication controller 118. NodeID values, which might range from 1 to 64 in some implementations, or which might have different ranges in other implementations, indicate the data came from a PCA 130. The value of NodeID might indicate which PCA 130 the data came from. Optionally, the PCA 130 possesses a “dongle”. Any other value can be considered invalid, in some instantiations, meaning that such a value will result in a CAN_FAIL return, as explained in the can_sts section, above.

data can be considered a pointer to a data structure that contains the actual data received from the partner application. Optionally, the can_data_T structure can be used. This data structure is described later.

In an exemplary embodiment, the optional can_data_T structure describes the actual message data that is exchanged between a monitoring application, which can be an electronic device 116 monitoring application, on the communication controller 118 and the PCA 130. An exemplary data structure, is as follows:

typedef struct
{

| | |
|---|---|
| int key; | // 16 bit message key (0xFFFF is reserved) |
| byte idx; | // 8 bit sub key |
| byte len; | // 8 bit data length |
| union | |
| { | |

| | |
|---|---|
| ULONG l_value; | // 32 bit value to send |
| ULONG la_value[64]; | // 32 bit value array to send |
| UINT i_value; | // 16 bit value to send |
| UINT ia_value[128]; | // 16 bit value array to send |
| byte b_value; | // 8 bit value to send |
| byte ba_value[256]; | // 8 bit value array to send |
| char str[256]; | // string |

}data;

} can_data_T;

This data structure, if used, is designed to accommodate sending either single binary values or strings of various lengths. In an exemplary embodiment, the length of the strings are up to 255 bytes long. Other embodiments use larger or smaller string lengths. The data structure can also be designed to allow sending data for single instance objects or for objects that are entries in a multiple entry table. In an exemplary embodiment, the data field is remapped using the C language UNION facility to allow sending 4 byte, 2 byte, 1 byte, or 255 byte string data. The fields in the structure and their meanings, in at least some exemplary implementations, are described below

If used, the can_data_T key field can be a 16 bite binary value that defines the type of data contained in the structure itself. Most of the values of this filed can correspond directly to the fields in the electronic device 116 data structure defined earlier, in an exemplary embodiment. Additionally, keys can be defined to allow downloading firmware to PCAs. In certain embodiments, keys also perform other system-related tasks, such as retrieving debug information. In some instances, a key in a message flowing from the communication controller 118 to at least one PCA 130 can be either a request for information regarding the specified key or a request to set a specific value for the key, in at least some implementations. If the message is a request for information, the high order bit of the key can be set. In certain embodiments, a key in a message flowing from a PCA 130 to the communication controller 118 is either a response or an unsolicited indication of the data value associated with the key.

In certain implementations, electronic device 116 Identification keys define messages that contain strings that identify a particular electronic device 116. An exemplary embodiment comprises 6 identification keys. Other embodiments comprise a different number of keys. Some embodiments comprise a set number of keys, while other embodiments use a variable number of keys. Data represented by these keys, in an exemplary embodiment, are 64 byte ASCII strings. Other embodiments have a different size for the strings, and some embodiments do not use ASCII strings. The following table describes an exemplary embodiment of the identification keys.

| Key Definition | | Data | | |
|---|---|---|---|---|
| Name | Value | type | Size | Description |
| Manufacturer | 1 | String | 64 | The name of the |
| | | | | electronic device |
| | | | | 116 manufacturer |
| Model | 2 | String | 64 | The electronic device |
| | | | | 116 Model designation |
| SoftwareVersion | 3 | String | 64 | The electronic device |
| | | | | 116 firmware/software |
| | | | | version(s). |
| AgentSoftwareVersion | 4 | String | 64 | The electronic device |
| | | | | 116 agent software |
| | | | | version. |
| Name | 5 | String | 64 | A string identifying |
| | | | | the electronic device |
| | | | | 116. |
| AttachedDevices | 6 | String | 64 | A string identifying |
| | | | | the devices attached |
| | | | | to the output(s) of |
| | | | | the electronic device |
| | | | | 116. |

The high order bit in the key can indicate whether the message is a request to set a value or a request to read the current value. In certain implementations, for those keys that are read only keys (such as Manufacturer and Model), the request can be a read request regardless of the value of the high bit.

In some implementations, electronic device 116 Battery Status keys define messages that are used to send the status of the electronic device 116 batteries to the communication controller 118. These keys can represent read only data that contain status information. In an exemplary embodiment there are 7 battery status keys. In such an embodiment, the data represented by these keys are all 4 byte integer values. Other embodiments may employ a different number of battery status keys, a different type and size for such keys, or may perform the implementation in another way known to those of skill in the art. In an embodiment which employs such keys, the following table describes example keys.

| Key Definition | | Data | | |
|---|---|---|---|---|
| Name | Value | type | Size | Description |
| Status | 7 | Integer | 4 | The indication of the |
| | | | | capacity remaining in |
| | | | | the electronic device |
| | | | | 116 system's batteries. |
| SecondsOn | 8 | Integer | 4 | If the unit is on battery |
| | | | | power, the elapsed time |
| | | | | (in seconds) since the |
| | | | | electronic device 116 |
| | | | | last switched to battery |
| | | | | power, or the time since |
| | | | | the network management |
| | | | | subsystem was last |
| | | | | restarted, whichever is |
| | | | | less. Zero can be |
| | | | | returned if the unit is |
| | | | | not on battery power |
| MinutesRemaining | 9 | Integer | 4 | An estimate of the time |
| | | | | (in minutes) to battery |
| | | | | charge depletion under |
| | | | | the present |
| | | | | load conditions if the |
| | | | | utility power is off and |
| | | | | remains off, or if it were |
| | | | | to be lost and remain off |
| ChargeRemaining | 10 | Integer | 4 | An estimate of the battery |
| | | | | charge remaining expressed |
| | | | | as a percent of full |
| | | | | charge. |
| Voltage | 11 | Integer | 4 | The magnitude of the |
| | | | | present battery voltage |
| | | | | expressed in 0.1 Volts DC |
| Current | 12 | Integer | 4 | The present battery |
| | | | | current expressed in 0.1 |
| | | | | Amps DC |
| Temperature | 13 | Integer | 4 | The ambient temperature at |
| | | | | or near the electronic |
| | | | | device 116 Battery |

In an implementation with uses keys as described above, the Status key data can be one of 4 possible values as follows:
Value=1—unknown—the PCA 130 cannot determine the status of the electronic device 116 batteries.
Value=2−batteryNormal—the remaining run-time is greater than the configured low battery time (upsConfigLowBattTime in the electronic device 116 structure).
Value=3—batteryLow—the remaining battery run-time is less than or equal to the configured low battery time (upsConfigLowBattTime in the electronic device 116 structure).
Value=4—batteryDepleted—the electronic device 116 will be unable to sustain the present load when and if the utility power is lost (including the possibility that the utility power is currently absent and the electronic device 116 is unable to sustain the output).

In certain implementations, electronic device 116 input source keys define the messages that contain information relating to the various input power sources for an electronic device 116. There may be multiple input sources for a single electronic device 116. Keys that relate to a specific input source for a specific electronic device 116 can be further identified in the message by the index field (idx) which specifies to which of the input sources a given message applies. Such embodiments can employ input source keys that apply to at least one, and possibly all, of the input sources. They may also use 4 input source keys that potentially apply to a specific input source (as identified by the idx field in the message). The data represented by these keys can be 4 byte integer values. Key sizes other than 4 bytes, values other than integer for the keys, and so on, can also be used, in other exemplary embodiments. Other values can be used, as well. The following table describes one embodiment of the input source keys.

| Key Definition | | Data | | |
|---|---|---|---|---|
| Name | Value | type | Size | Description |
| InputLineBads | 14 | Integer | 4 | A count of the number of |
| | | | | times the input entered an |
| | | | | out-of-tolerance condition |
| | | | | as defined by the |
| | | | | manufacturer. This count |
| | | | | is incremented by |
| | | | | one each time the input |
| | | | | transitions from zero |
| | | | | out-of-tolerance lines |
| | | | | to one or more input lines |
| | | | | out-of-tolerance. |
| InputNumLines | 15 | Integer | 4 | The number of input lines |
| | | | | utilized in this device. |
| | | | | This variable indicates |
| | | | | the number of rows in the |
| | | | | input table. |
| InputFrequency | 16 | Integer | 4 | Present input frequency |
| | | | | in 0.1 Hertz. |
| InputVoltage | 17 | Integer | 4 | Magnitude of the present |
| | | | | input voltage in RMS Volts. |
| InputCurrent | 18 | Integer | 4 | Magnitude of the present |
| | | | | input current in 0.1 RMS |
| | | | | Amps. |
| InputTruePower | 19 | Integer | 4 | Magnitude of the present |
| | | | | input true power in Watts. |

In an implementation such as described above, the Input Frequency, Voltage, Current and True Power keys can refer to specific input sources. In such a case, the input source is identified by the idx field in the message.

Electronic device 116 Output Power keys can define the messages that contain information relating to the output power for an electronic device 116, in certain embodiments. In such embodiments, there may be multiple output lines for a single electronic device 116. Keys that relate to a specific output line can be further identified in the message by the index field (idx) which specifies to which of the output lines the message applies. Some embodiments use 3 output line keys that apply to all of the output lines and 4 output line keys that apply to a specific output line (as identified by the idx field in the message). Other embodiments use a different number of line keys to apply to a specific output line and/or to apply to all of the output lines. The data represented by such keys can be 4 byte integer values, or can be of different sizes and types. The following table describes example output power keys.

| Key Definition | | Data | | |
|---|---|---|---|---|
| Name | Value | type | Size | Description |
| OutputSource | 20 | Integer | 4 | The present source of |
| | | | | output power. The data |
| | | | | for this key in this |
| | | | | embodiment is from 1 |
| | | | | to 7. The possible |
| | | | | values for this field |
| | | | | are described following |
| | | | | this table. |
| OutputFrequency | 21 | Integer | 4 | Present output frequency |
| | | | | in 0.1 Hertz. |
| OutputNumLines | 22 | Integer | 4 | The number of output |
| | | | | lines utilized in this |
| | | | | device. This variable |
| | | | | indicates the number |
| | | | | of rows in the output |
| | | | | table |
| OutputVoltage | 23 | Integer | 4 | Present output voltage |
| | | | | in RMS Volts for this |
| | | | | output line. |
| OutputCurrent | 24 | Integer | 4 | Present output current |
| | | | | in 0.1RMS Amps for this |
| | | | | output line. |
| OutputPower | 25 | Integer | 4 | Present output true power |
| | | | | in Watts for this output |
| | | | | line. |
| OutputPercentLoad | 26 | Integer | 4 | The percentage of the |
| | | | | electronic device 116 power |
| | | | | capacity presently being |
| | | | | used on this output line, |
| | | | | i.e., the greater of the |
| | | | | percent load of |
| | | | | true power capacity |
| | | | | and the percent load of VA |

In an implementation as described above, the Output Voltage, Current, Power and Percent Load keys refer to specific output lines. In such a case, the output line can be identified by the idx field in the message.

The OutputSource key data can be one of the following values:
Value=1—other—undefined source.
Value=2—none—no source of output power (and therefore no output power), for example, the system has opened the output breaker
Value=3—normal—output power is from the normal source.
Value=4—bypass—output power is from the bypass source
Value=5—battery—output power is from the batteries.
Value=6—booster—output power is from the booster source.
Value=7—reducer—output power is from the reducer source.

Electronic device 116 bypass keys can be implemented to define messages that contain information relating to the bypass lines for an electronic device 116. In such a case, there may be multiple bypass lines for a single electronic device 116. Keys that relate to a specific bypass line can be further identified in the message by the index field (idx) which specifies to which of the bypass lines the message applies. There can be, in an exemplary embodiment, 2 bypass line keys that apply to all of the bypass lines and 3 bypass line keys that apply to a specific bypass line (as identified by the idx field in the message). The data represented by these keys, in at least some embodiments, can be 4 byte integer values. The following table describes example bypass line keys.

| Key Definition | | Data | | |
|---|---|---|---|---|
| Name | Value | type | Size | Description |
| BypassFrequency | 27 | Integer | 4 | Present output frequency |
| | | | | in 0.1 Hertz. |
| BypassNumLines | 28 | Integer | 4 | The number of bypass lines |
| | | | | utilized in this device. |
| | | | | This variable indicates |
| | | | | the number of rows in the |
| | | | | bypass table |
| BypassVoltage | 29 | Integer | 4 | Present output voltage in |
| | | | | RMS Volts for this bypass |
| | | | | line. |
| BypassCurrent | 30 | Integer | 4 | Present output current |
| | | | | in 0.1 RMS Amps for this |
| | | | | bypass line. |
| BypassPower | 31 | Integer | 4 | Present output true power |
| | | | | in Watts for this bypass |
| | | | | line. |

In an implementation such as that described above, the Bypass Voltage, Current, and Power keys can refer to specific bypass lines. In such a case, the bypass line is identified by the idx field in the message.

An electronic device 116 Alarm Key can be used to send alarm information messages. Alarm messages sent from the PCA 130 to the communication controller 118 generally result in SNMP traps being generated. In an example embodiment, the data in the alarm key message consists of an array of 4 integers that describe the alarm. In a further example embodiment, all messages that use the Alarm Key have the index field (idx) in the message set to 0 (zero). The following table describes an example alarm key.

| Key Definition | | Data | | |
|---|---|---|---|---|
| Name | Value | type | Size | Description |
| Alarm | 32 | Integer | 16 | The data in this message is an |
| | | array | | array of 4 integers. The first |
| | | | | entry is the number of alarm |
| | | | | conditions currently active. |
| | | | | The second entry is a unique |
| | | | | identifier for the alarm. The |
| | | | | third entry is one of the entries |
| | | | | from an alarm description |
| | | | | table that describes this alarm. |
| | | | | The fourth (last) entry is the |
| | | | | value of sysUpTime when the |
| | | | | alarm condition was detected. |
| | | | | If the alarm condition was |
| | | | | detected at the time of agent |
| | | | | startup and presumably existed |
| | | | | before agent startup, the value |
| | | | | can equal 0. |

The alarm information is not retained by the PCA 130, in some implementations. Rather, it is saved by the communication controller 118.

Electronic device 116 test keys, in some implementations, define the messages that contain information relating to various tests that can be performed on an electronic device 116. The following table describes example test keys.

| Key Definition | | Data | | |
|---|---|---|---|---|
| Name | Value | type | Size | Description |
| TestStart | 33 | Integer | 4 | Begin (or abort the |
| | | | | current test) the |
| | | | | test specified by |
| | | | | the integer |
| | | | | specified in the |
| | | | | data field. |
| | | | | This variable |
| | | | | identifies the |
| | | | | current (or last) |
| | | | | test as |
| | | | | defined by tests |
| | | | | identified following |
| | | | | this table. |
| TestResultsSummary | 34 | Integer | 12 | The results of the |
| | | array | | current or last |
| | | | | electronic device |
| | | | | 116 diagnostics are |
| | | | | returned in a 3 integer |
| | | | | array. The first integer |
| | | | | in the array is the |
| | | | | value of sysUpTime at |
| | | | | the time the test in |
| | | | | progress was initiated, |
| | | | | or, if no test is |
| | | | | in progress, the time |
| | | | | the previous test was |
| | | | | initiated. The second |
| | | | | integer in the |
| | | | | array is the amount |
| | | | | of time since the test |
| | | | | in progress |
| | | | | was initiated, or, if |
| | | | | no test is in |
| | | | | progress, the previous |
| | | | | test took to complete. |
| | | | | The third integer in |
| | | | | the array contains the |
| | | | | test results. Possible |
| | | | | results and their |
| | | | | descriptions follow |
| | | | | this table. |
| TestResultsDetail | 35 | String | 255 | Additional |
| | | | | information about |
| | | | | TestResultsSummary. |
| | | | | If no additional |
| | | | | information |
| | | | | available, a zero |
| | | | | length string is |
| | | | | returned |

Example tests that that can be specified in the data of the TestStart key in the table in some versions of the implementation above are:
Value=1—no tests have been initiated and no test is in progress.
Value=2—the test in progress is to be aborted/the test in progress was aborted.
Value=3—the manufacturer's standard test of electronic device 116 device systems.
Value=4—a test that is sufficient to determine if the battery needs replacement.
Value=5—the system is placed on battery to a discharge level, set by the manufacturer, sufficient to determine battery replacement and battery run-time with a high degree of confidence. In certain implementations this test will leave the battery in a low charge state and will require time for recharging to a level sufficient to provide normal battery duration for the protected load.

The summary test results returned, optionally, in the third integer of the TestResultsSummary key, in certain implementations, are as follows:
Value=1—the test completed successfully (donePass).
Value=2—the test completed with a warning (doneWarning).
Value=3—the test completed with an error (doneError).
Value=4—the test was aborted by setting the TestStart key to a value of 2 (aborted).
Value=5—the test has not yet completed (in Progress).
Value=6—no previous test results are available noTestsInitiated).

The electronic device 116 control keys can define the messages that contain information relating to controlling various functions on an electronic device 116, in some exemplary implementations. The following table describes example control keys.

| Key Definition | | Data | | |
|---|---|---|---|---|
| Name | Value | type | Size | Description |
| ShutdownType | 36 | Integer | 4 | Sets the action to be |
| | | | | taken when the |
| | | | | countdown of the |
| | | | | ShutdownAfterDelay |
| | | | | and RebootWithDuration |
| | | | | objects reaches zero. |
| | | | | Value = 1 turn off |
| | | | | output only. |
| | | | | Value = 2 turn |
| | | | | off entire electronic |
| | | | | device 116. |
| ShutdownAfterDelay | 37 | Integer | 4 | Used to initiate a |
| | | | | shutdown using a |
| | | | | delay (in seconds) |
| | | | | specified in the |
| | | | | integer value. |
| | | | | Value = 0 - |
| | | | | shutdown now. |
| | | | | Value = −1 - |
| | | | | abort. When read, |
| | | | | it returns the |
| | | | | number of seconds |
| | | | | until shutdown |
| | | | | or −1 if no |
| | | | | countdown is in |
| | | | | effect. |
| StartupAfterDelay | 38 | Integer | 4 | Used to start the |
| | | | | output using a |
| | | | | delay (in seconds) |
| | | | | specified in the |
| | | | | integer value. |
| | | | | Value = 0 - |
| | | | | startup now. |
| | | | | Value = −1 - |
| | | | | abort. When read, |
| | | | | it returns the number |
| | | | | of seconds until |
| | | | | startup or −1 if |
| | | | | no countdown is in |
| | | | | effect. |
| RebootWithDuration | 39 | Integer | 4 | Used to turn off |
| | | | | power, delay for |
| | | | | the specified |
| | | | | number of seconds |
| | | | | and then turn on |
| | | | | power. When read, |
| | | | | it returns the |
| | | | | number of seconds |
| | | | | until startup |
| | | | | or −1 if no |
| | | | | countdown is in |
| | | | | effect. |
| AutoRestart | 40 | Integer | 4 | A value of 1 (on) |
| | | | | will cause the |
| | | | | electronic |
| | | | | device 116 system |
| | | | | to restart after |
| | | | | a shutdown. |
| | | | | Setting this object |
| | | | | to a value of 2 (off) |
| | | | | will prevent the |
| | | | | electronic device 116 |
| | | | | system from restarting |
| | | | | after a shutdown until |
| | | | | an operator manually or |
| | | | | remotely explicitly |
| | | | | restarts it. |

As specified earlier, keys that are used to query the value of the key can have the high order bit of the key set. If used, this allows the PCA 130 to determine if the specified key is meant to initiate a control function or to query the current setting of the key's value. For example, the StartupAfterDelay can be used to initiate a start up function or to query the countdown on an exiting StartupAfterDelay request. In certain embodiments, for the query request, the high order bit will be set in the StartupAfterDelay key.

In some implementations, with the RebootWithDuration key, if the number of seconds required to perform the request is greater than the requested duration, then the requested shutdown and startup cycle can be performed in the minimum time possible, but in no case can this require more than the requested duration plus 60 seconds. Certain other implementations set a different time for the shutdown and startup cycle. At least some implementations set a different time for the shutdown cycle than for the startup cycle.

In certain embodiments, the electronic device 116 Configuration Keys define the messages that contain information relating to configuring an electronic device 116. The following table describes example configuration keys.

| Key Definition | | Data | | |
|---|---|---|---|---|
| Name | Value | type | Size | Description |
| ConfigInputVoltage | 41 | Integer | 4 | Set/query the nominal |
| | | | | input voltage in RMS |
| | | | | Volts. |
| ConfigInputFreq | 42 | Integer | 4 | Set/query the nominal |
| | | | | input frequency in 0.1 |
| | | | | Hertz. |
| ConfigOutputVoltage | 43 | Integer | 4 | Set/query the nominal |
| | | | | output voltage in RMS |
| | | | | Volts. |
| ConfigOutputFreq | 44 | Integer | 4 | Set/query the nominal |
| | | | | output frequency in 0.1 |
| | | | | Hertz. |
| ConfigOutputVA | 45 | Integer | 4 | Set/query the magnitude |
| | | | | of the nominal Volt-Amp |
| | | | | rating. |
| ConfigOutputPower | 46 | Integer | 4 | Set/query the magnitude |
| | | | | of the nominal true power |
| | | | | rating in Watts. |
| ConfigLowBattTime | 47 | Integer | 4 | Set/query the value of |
| | | | | EstimatedMinutesRemaining |
| | | | | at which a lowBattery |
| | | | | condition is declared. |
| ConfigAudibleStatus | 48 | Integer | 4 | Set/query the state of |
| | | | | the audible alarm. |
| | | | | Possible values are |
| | | | | listed after this table. |
| ConfigLowVoltage- | 49 | Integer | 4 | Set/query the minimum |
| TransferPoint | | | | input line voltage |
| | | | | allowed before the |
| | | | | electronic device 116 |
| | | | | system transfers to |
| | | | | battery backup |
| ConfigHighVoltage- | 50 | Integer | 4 | Set/query the maximum |
| TransferPoint | | | | line voltage allowed |
| | | | | before the electronic |
| | | | | device 116 system |
| | | | | transfers to battery |
| | | | | backup. |

As specified earlier, in at least some implementations, keys that are used to query the value of the key have the high order bit of the key set. When used, this allows the PCA 130 to determine if the specified key is meant to set a configuration value or whether it is meant to query the current setting of the key's value.

If there is an attempt to set ConfigInputFreq, ConfigInputVoltage, ConfigOutputFreq, or ConfigOutputVoltage to a value that is not supported, in some embodiments, the request can be rejected and the agent can respond with an appropriate error message, i.e., badValue for SNMPv1, or inconsistentValue for SNMPv2.

In some embodiments that employ electronic device 116 configuration keys, if the ConfigLowBattTime value is between values supported by the electronic device 116, then the value can be rounded up to the next supported value. If the requested value is larger than the largest supported value, then the largest supported value can be selected.

The possible values for the ConfigAudibleStatus key and their meanings, in an example embodiment, are:
Value=1—disabled—the audible alarm should never sound.
Value=2—enabled—the audible alarm should sound when appropriate.
Value=3—muted—if the audible alarm is sounding, temporarily silence the alarm. It will remain muted until it would normally stop sounding and the value returned for read operations during this period can equal muted (3). At the end of this period, the value can revert to enabled (2). Writes of the value muted (3) when the audible alarm is not sounding can be accepted but otherwise can have no effect.

System keys can be used for internal maintenance functions such as code updates and debugging, in certain implementations. Example system keys are described in the following table.

| Key Definition | | Data | | |
|---|---|---|---|---|
| Name | Value | type | Size | Description |
| CurrentPCAVersion | 128 | Integer | 4 | The current firmware |
| | | | | version of the PCA 130. |
| FirmwareLoad | 129 | Integer | 256 | Send a packet of data that |
| | | Array | | contains firmware for the |
| | | | | PCA 130. |
| DebugInfo | 130 | Integer | 256 | If the high order bit is |
| | | Array | | set in the key it is a |
| | | | | request for information. |
| | | | | If the bit is not |
| | | | | set, the data within |
| | | | | the integer array itself |
| | | | | is the information. |

If used, the can_data_T idx field can be an 8 byte binary value that is used to indicate to which entry in a table of objects the data applies. For single entry objects the idx field can set to a value of 0.

If used, the can_data_T len field is an 8 byte binary value that specifies the number of bytes of data in can_data_T “data” field.

In embodiments in which it is used, the can_data_T data field can be a C UNION that re-maps the 255 byte field into the various types of data that can be transmitted using this structure. The field can contain binary values of 32 bits, 16 bits, or 8 bits as well as ASCII strings up to 255 bytes long. Other embodiments employ different sizes of binary values and ASCII strings, or different data types altogether.

The communication controller 118, in one embodiment, includes a single network address, such as a TCP/IP address. Each PCA 130 communicates with the communication controller 118 and utilizes the single communication controller 118 network address. Thus, each PCA 130 will not require an individual network address, although in some instances this may be beneficial and may be implemented. Likewise, the communication controller 118, in some embodiments, includes multiple network addresses.

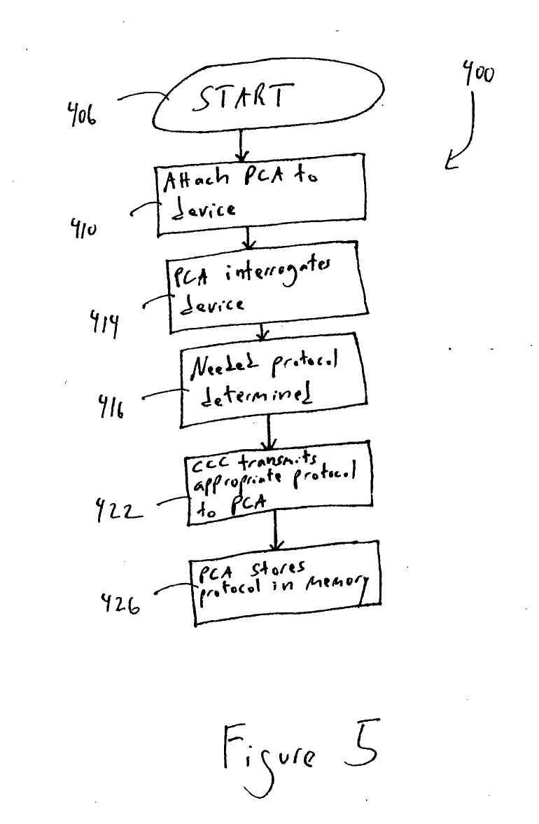

An embodiment of a process for a PCA 130 obtaining a protocol from the communication controller 118 is depicted in FIG. 5. The method 400 starts at step 406 and, at step 410, a PCA 130 connects to an electronic device 116. At step 414, the PCA 130 interrogates the electronic device 116 to determine what protocol is required for communication with the electronic device 116. This determination may be made by the PCA 130 or the communication controller 118 at step 416. Once it is determined what protocol the PCA 130 needs, the communication controller 118 transmits the appropriate protocol to the PCA 130 at step 422. At step 426, the PCA 130 stores the protocol in memory.

In further embodiments, the PCA 130 may be used with multiple electronic devices 116. In an exemplary embodiment, these multiple devices 116 can be from multiple vendors. When the PCA 130 is removed from a first electronic device 116 and connected to a second electronic device 116, if the protocol stored by the PCA 130 is incorrect for the second device, this may be detected, the old protocol optionally erased from the memory 254 of the PCA 130, and the new protocol obtained from the communication controller 118 and stored in the memory 254.

In particular embodiments of the disclosure, network security is important to the integrity of the communication network. If desired, the communication network can be configured for multiple user access through several interfaces. In a particular implementation, access to electronic devices 116 requires user authentication against a pre-configured user database. In some instances, the interface is an HTML Web interface, such an interface that supports Basic and MD5 authentication. The Basic authentication uses Base 64 encoding for username and passwords. The MD5 authentication uses a “one way” hash of the username/password so that the password is never sent in “clear-text,” thereby protecting the integrity of the data.

A secure proxy, which can be implemented as a secure tunnel through which non-secure local host network data and commands are sent, is used in some implementations. The secure tunnel can be used to provide security for HTTP and Telnet communications. Certain embodiments of a secure system employ two levels of encryption, for example implementing both DES-CBC (56 bit key) and Blowfish-CBC (128 bit key). The secure proxy may be selected to provide support for MD5 & HMAC MD5 for authentication and integrity checks. In order to prevent replay attacks and maintain system time, SNTP time protocol is used in some embodiments. A windows secure agent application provides client side access in addition to power control management.

In alternate embodiments employing system security, Secure Socket Layer (SSL) security, which provides up to 2048 bit RSA encryption of all HTTP sessions, is used. In this embodiment, no client side application is required and access is provided through a standard web browser. Certificates are used to provide integrity checks for connecting parties. Secure Shell (SSH), Transport Security Layer (TSL), Secure SNMP, or other protocols may be used to provide secure communications.

The methods, systems, and apparatus of the various embodiments of the present disclosure may allow electronic devices to be conveniently monitored or controlled. In addition, certain embodiments conserve network addresses since only the controller needs to be given a network address. Given the number of devices in a typical rack, the number of network addresses saved can be substantial. In addition, certain embodiments allow a single controller to serve a plurality of racks. In yet further embodiments, the controller may be integrated into an existing rack device, such as a PDU, thus reducing the amount of rack space taken up in order to implement disclosed embodiments.

There are many examples of device monitoring and controlling that may be accomplished using the disclosed embodiments. For example, a controller may be attached to a PDU that supplies power to one or more attached pieces of electronic equipment through a plurality of power outlets. The power outlets may be organized in multiple branches which may be independently fused, powered, monitored, or controlled. Embodiments of the present disclosure allow one or more of the following to be measured: the total current drawn by the PDU, the on/off status of devices attached to the PDU, the current drawn by a particular branch, and environmental conditions such as temperature or humidity. Further embodiments allow one or more outlets to be turned off or on, such as to reboot locked up equipment or to prevent unauthorized access to unused outlets. An example of such a PDU is the Power Tower XL, available from Server Technology, Inc. of Reno, Nev.

Some embodiments of the present disclosure allow for remote monitoring or control of network equipment, such as servers. In at least one embodiment, the server may be accessed through a “Lights Out” card. Once the server is accessed, a variety of tasks can be performed. For example, a user may check the remaining amount of storage space left on the server. Examples of servers utilizing “Lights Out” technology are the ProLiant servers available from Hewlett-Packard Co. of Palo Alto, Calif.

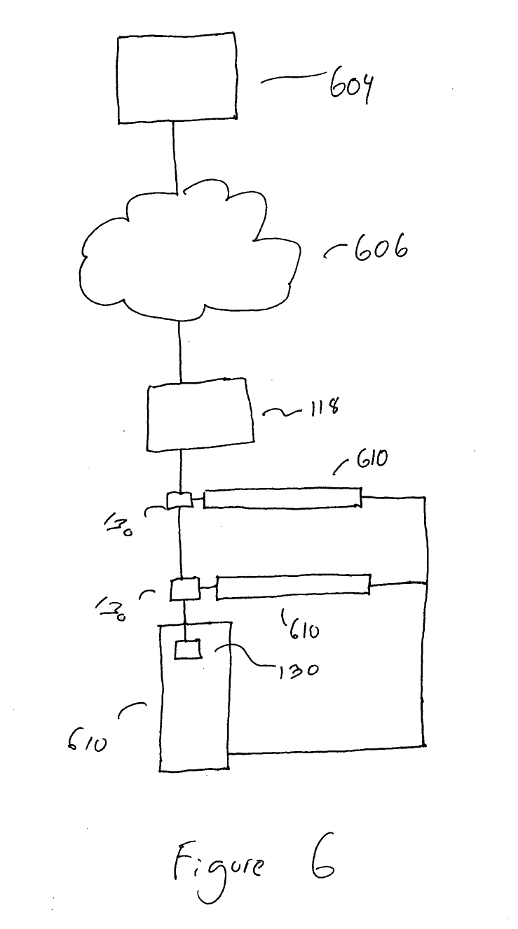

In certain embodiments, such as the system 500 shown in FIG. 6, the communication controller 118 is in communication with a management application 604 through a communication connection 606. Examples of management applications 604 include IBM's Tivoli, Computer Associate's Unicenter, and HP's OpenView software packages. The management application 604 allows remote control of devices 610 attached to the communication controller 118. The communication connection 610 may be selected as appropriate. Suitable communication connections 610 include the publicly switched telephone network and networks such as the Internet, a LAN, a WAN, or a VPN.

The communication controller 118 may receive commands from the management application 604 and pass the commands to an appropriate PCA 130, or may process the command and take action with the appropriate PCA 130. For example, the communication controller 118 and the management application 604 may cooperate to provide a remote user with information regarding the operational status of an electronic device 610, such as the on/off status, current draw, or physical environment of the device 610, a component thereof or a piece of equipment attached thereto. Similarly, the management application 604, in conjunction with the communication controller 118, may issue commands to the device (or equipment attached thereto), such as commands to power on, power off, reboot, or transfer a load of the device 610 or a component or piece of equipment attached thereto.

Compared to prior implementations of management applications 604, the disclosed systems may provide a number of advantages. For example, at least in certain implementations, the management application 604 need only communicate with the communication controller 118, rather than numerous individual components, thus simplifying communications. In addition, because of the architecture of at least certain disclosed systems, the management application 604 may communicate with a greater number of devices 610 or communicate with such devices 610 over longer distances, yet through a single controller. The use of PCAs 130 may also reduce expenses associated with implementing such a system.

Certain racks contain separate environmental sensors. These environmental sensors can be connected to a PCA 130 and thus be placed in communication with a communication controller 118. Once the environmental sensor is in communication with the communication controller 118, it can be monitored by a remote user.

Contact closures may be used to determine when doors or other mechanisms are open or closed. The contact closures may be connected to a PCA 130 in communication with the communication controller 118. Thus, the PCA 130 may be used to communicate the status of the contact closure to the communication controller 118, which may generate a suitable notice to a remote user. In certain implementations, the user may issue request to query the status of a particular closure. Certain embodiments allow the user to reset the sensor if it is determined that the sensor has malfunctioned.

The contact closure feature may be used in a variety of automated rack systems, such as to control equipment such as satellite receivers, store-forward systems, printers, fax machines, or other automated or communication equipment. This equipment may be mounted in a rack or utilized in association with equipment in a rack.

It is to be understood that the above discussion provides a detailed description of preferred embodiments. The above descriptions of the preferred embodiments will enable those skilled in the art to make many departures from the particular examples described above to provide apparatus constructed in accordance with the present disclosure. The embodiments are illustrative, and not intended to limit the scope of the present disclosure. The scope of the present disclosure is rather to be determined by the scope of the claims as issued.

What is claimed is:

1. A communications system of the type useable to allow external communication with one or more electronic devices, the communications system comprising:
(A) a peripheral communications adapter communicatingly connectable to an electronic device, the peripheral communications adapter comprising:
i. a first communications interface;
ii. a second communications interface communicatingly connectable with the electronic device;
iii. a memory having communications protocol storage, the communications protocol storage operable to store a communications protocol for communicating with the electronic device;
iv. a processor in communication with the memory, the first communications interface, and the second communications interface, the processor operable to translate, according to the communications protocol, communications received from the first communications interface for transmission to the electronic device through the second communications interface;
(B) a controller in communication with the first communications interface, the controller comprising:
i. a network adapter configured to receive communications from a remote user over a network;
ii. a first communications port configured to transmit data to the first communications interface; and
iii. a processor configured to process requests received from the network;
whereby a user may monitor or control the electronic device over the network by issuing requests that are received by the controller and sent to the peripheral communications adapter.

2. The communications system of claim 1, wherein the electronic device is an electronic device in a data center equipment cabinet.

3. The communications system of claim 2, further comprising the electronic device.

4. The communications system of claim 1, wherein the peripheral communications adapter is separate from the electronic device.

5. The communications system of claim 1, wherein the peripheral communications adapter is integrated into the electronic device.

6. The communications system of claim 1, wherein the peripheral communications adapter comprises a communications protocol polling module configured to poll the electronic device to determine an appropriate communication protocol, communicate with the controller, and receive the appropriate communication protocol from the controller.

7. The communications system of claim 1, wherein the peripheral communications adapter is preprogrammed with a communications protocol.

8. The communications system of claim 1, wherein the network adapter is a TCP/IP adapter or an Ethernet adapter.

9. The communications system of claim 1, further comprising a communications buss, the communications buss communicatingly connecting the first communications port communications with the first communications interface.

10. The communications system of claim 9, wherein the communications buss is a multidrop buss.

11. The communications system of claim 9, wherein the communications buss is a CAN bus.

12. The communications system of claim 1, wherein the controller includes an SNMP module operable to transmit and receive SNMP commands.

13. The communications system of claim 1, wherein the controller is in communication with a plurality of peripheral communication adapters, the plurality of peripheral communication adapters connected in a daisy chain configuration.

14. The communications system of claim 1, wherein the communications port is one of a plurality of communications ports, the controller being in communication with a plurality of peripheral communication adapters, the plurality of peripheral communication adapters connected in a star configuration.

15. The communications system of claim 1, wherein the peripheral communications adapter and the controller are located in a computer equipment rack.

16. The communications system of claim 1, wherein one of the controller and the peripheral communications adapter is located in the computer equipment rack and one of the controller and the peripheral communications adapter is located external to the computer equipment rack.

17. The communications system of claim 1, wherein the PCA is one of a plurality of PCAs, further comprising the plurality of PCAs and a plurality of equipment racks, the plurality of PCAs being distributed among the plurality of equipment racks.

18. The communications system of claim 1, further comprising a management application in communication with the controller over the network, whereby the management application is operable to allow the user to send requests to the electronic device over the network to the controller.

19. The communications system of claim 1, further comprising a management application in communication with the controller over a network, whereby the management application is operable to allow the user to view information regarding the electronic device.

20. The communications system of claim 1, the controller comprising a memory storing a plurality of communication protocols.

21. The communications system of claim 1, wherein the first communication port is a wireless communication port and the first communication interface is a wireless communication interface and configured to receive wireless communications from the wireless communication port.

22. A communications controller of the type useable to transmit requests received over a network to an electronic component, the communications controller comprising:
(A) a housing mountable in a computer equipment rack;
(B) a microcontroller system mounted within the housing and comprising:
i. a network adapter connectable to a network and configured to transmit and receive data over the network;
ii. a processor, the processor configured to facilitate communications between a remote user communicating over the network and an electronic device;
iii. a memory in communication with the processor, the memory comprising a plurality of communication protocols configured to be transmitted to a remote secondary controller, the remote secondary controller being connectable to the electronic device;
iv. a communications port in communication with the processor and configured to send data to, and receive data from, the remote secondary controller.

23. The communications controller of claim 22, further comprising an SNMP communications protocol configured to be executed on the processor and to facilitate communications from the network adapter to the communications port.

24. The communications controller of claim 22, further comprising a network communication protocol selected from the group consisting of SNMP, TCIP/IP, Ethernet, and http.

25. The communications controller of claim 22, wherein the communications port is one of a plurality of communication ports in communication with the processor and configured to send data to, and receive data from, the remote secondary controller.

26. The communications controller of claim 25, wherein the plurality of communication ports are connectable to a corresponding plurality of remote secondary controllers connected to a corresponding plurality of electronic devices in a star configuration.

27. The communications controller of claim 22, wherein the communication port is connectable to a plurality of remote secondary controllers connected to a corresponding plurality of electronic devices in a daisy chain configuration.

28. The communication controller of claim 22, wherein the communication port is a CAN buss interface.

29. The communication controller of claim 22, wherein the communication port is a multidrop buss interface.

30. The communications controller of claim 22, further comprising a management application interface protocol, the management application interface protocol configured to receive requests over the network from a management application, process the requests, and transmit the requests to the remote secondary controller through the communications port.

31. The communications controller of claim 22, wherein the communications port is a wireless communications port.

32. A method for communicating a request from a remote user to an electronic device, the method comprising:
transmitting a request from a remote user to a controller over a network;
processing the request using the controller;
transmitting the request from the controller to a peripheral communications adapter;
processing the request using the peripheral communications adapter; and
at least one of:
obtaining operational data from the electronic device; and
transmitting the request to the electronic device and, based on the request transmitted to the electronic device, changing an operational parameter of the electronic device.

33. The method of claim 32, wherein transmitting a request from a remote user to a controller over a network comprising transmitting the request from a management application, through the network, to the controller.

34. The method of claim 32, wherein transmitting the request from a management application, through the network, to the controller comprises sending a request encoded in the SNMP protocol.

35. The method of claim 32, further comprising:
transmitting operational data from the electronic device to peripheral communications adapter;
transmitting the operational data from the communications adapter to the controller; and
transmitting the operational data from the controller to the remote user.

36. The method of claim 35, wherein transmitting the operational data from the controller to the remote user comprises transmitting the operational data from the controller to a management application.

37. The method of claim 32, wherein processing the request using the controller comprises encoding the request in a buss communication.

38. The method of claim 32, wherein processing the request using the peripheral communications adapter comprises encoding the request in a device protocol.
